(19) United States
(12) Patent Application Publication
(10) Pub. No.: US 2010/0077135 A1
(43) Pub. Date: Mar. 25, 2010

(54) MEMORY WEAR LEVELING METHOD, SYSTEM AND DEVICE

(75) Inventors: Rong Li, San Diego, CA (US); Yuefeng Jin, San Diego, CA (US); Li Wang, San Diego, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TELECOM, INC., San Diego, CA (US)

(21) Appl. No.: 12/499,859

(22) Filed: Jul. 9, 2009

(30) Foreign Application Priority Data
Sep. 23, 2008 (CA) 200810149370.6

(51) Int. Cl. G06F 12/02; G06F 12/00

(52) U.S. Cl. 711/103; 711/E12.001; 711/E12.008

(57) ABSTRACT

A wear leveling method for a non-volatile memory is provided. The non-volatile memory includes a plurality of data blocks, each corresponding to a time value. The data blocks are arranged according to a sequence of the time values corresponding thereto. The arranged blocks form a key table. An erase operation is determined whether to be executed for the data blocks. When the erase operation is executed for the data blocks, the corresponding data block is erased according to a sequence of the time values of the data blocks in the key table.

### CROSS REFERENCE TO RELATED APPLICATIONS

This Application claims priority of China Patent Application No. 200810149370.6, filed on Sep. 23, 2008, the entirety of which is incorporated by reference herein.

### BACKGROUND OF THE INVENTION

1. Field of the Invention

The invention relates to wear leveling methods and related apparatuses for storage medium management systems, and more particularly, to wear leveling methods and related apparatuses for medium management systems of mass storage equipment.

2. Description of the Related Art

Non volatile memory such as an electronically erasable programmable read-only memory (EEPROM), is a mass storage medium having a physical character that writes data by a data unit and erases data by data blocks. The non volatile memory is formed by one or more storage units, wherein each storage unit stores one or more data bits. EEPROM is typically used in Plug & Play cards for storing hardware configuration data and also used in a “hardware lock” for preventing software from being copied by unauthorized users.

Generally, EEPROM performs erase operations by dividing the storage units into erasable blocks. However, during operation, due to physical limitations of the EEPROM, useable lifespan of the erasable blocks are relatively short. Specifically, the number of times a single erasable block of an EEPROM can be erased/rewritten is usually within the 100000-1000000 range. Thus, during erase operations, if a specific block is frequently erased and the useable lifespan is exhausted, the useable lifespan of the entire storage medium is affected.

Therefore, a wear leveling technique is used with the erase operation so that blocks to be erased are distributed more evenly. One direct method for implementing the wear leveling technique is to record an erase count for each block and select the block with the lowest erase count as the block to be erased.

However, a drawback to the direct method for erase count recording is that the erase counts for the data blocks may be lost when a power is off during the block erase operation. In such a case, a deviation may occur in the subsequent block wear leveling processes, wherein the erase count record of blocks may not match the actual useable lifespan of the blocks.

### BRIEF SUMMARY OF THE INVENTION

A memory system, wear leveling method and apparatus for a non volatile memory are disclosed to overcome the aforementioned problems.

A wear leveling method for a non-volatile memory, wherein the non-volatile memory includes a plurality of data blocks and a key table corresponding to the plurality of data blocks, the method comprising: arranging the key table according to a sequence of time values corresponding to the plurality of data blocks, determining whether to execute an erase operation for at least one of the plurality of data blocks according to the arranged sequence of the plurality of data blocks indicated in the arranged key table; and updating the time values of the at least one data block in response to the erase operation of the at least one data block is determined to be executed,

A wear leveling apparatus for a non-volatile memory, wherein the non-volatile memory includes a plurality of data blocks and a key table corresponding to the plurality of data blocks, the apparatus comprising a level shifting module, arranging the key table according to a sequence of time values corresponding to the plurality of data blocks, an erase determination module coupled to the level shifting module, determining whether to execute an erase operation for at least one of the plurality of data blocks according to the arranged sequence of the plurality of data blocks indicated in the arranged key table; and a recording module, couple to the erase determination module, updating the time values of the at least one data block in response to the erase operation of the at least one data block is determined to be executed.

A memory system is further disclosed. The memory system comprises a plurality of data blocks and a key table corresponding to the plurality of data blocks, wherein the data blocks are erasable; an address mapping apparatus, storing physical addresses of the plurality of data blocks and recording a time value corresponding to the plurality of data blocks after at least one of the plurality of data blocks have been erased; a wear leveling apparatus connected to the address mapping apparatus, determining whether to execute a recycling erase operation for the plurality of data blocks according to a random number and a wear leveling seed; and a storage space recycling apparatus, managing the erased at least one of the plurality of data blocks for data rewriting or reading.

Embodiments of the invention utilize erase time stamps for erasable blocks as erase marks to reflect wear statuses for the data blocks and utilize a wear leveling seed to restrict wear leveling.

### BRIEF DESCRIPTION OF THE DRAWINGS

The invention can be more fully understood by reading the subsequent detailed description and examples with reference to the accompanying drawings, wherein:

FIG. 1A shows a block diagram of an embodiment of an application system for a non volatile memory according to the invention;

FIG. 1B shows a detailed structural diagram of an embodiment of a wear leveling module according to the invention;

FIG. 2 is a flowchart showing an embodiment of a wear leveling erasing method according to the invention;

FIG. 3A shows a schematic diagram of an embodiment of a key table arranged according to a sequence of the time values according to the invention;

FIG. 3B is a flowchart showing an embodiment of establishing an erasable blocks key table according to a sequence of the erase time stamps according to the invention;

FIG. 4A shows a schematic diagram of an embodiment of an erase operation for erasing a time stamp key table according to the invention;

FIG. 4B is a flowchart showing an embodiment of recording the erased time stamp to the erasable block according to the invention;

FIG. 5A is a flowchart showing an embodiment of a recycling process for the erasable blocks according to the invention; and

FIG. 5B shows a schematic diagram of an embodiment of a recycling operation for recycling the time stamp key table according to the invention.

### DETAILED DESCRIPTION OF THE INVENTION

The following description is of the best-contemplated mode of carrying out of the invention. This description is made for the purpose of illustrating the general principles of the invention and should not be taken in a limiting sense. The scope of the invention is best determined by reference to the appended claims.

To solve the aforementioned problems in the current art, embodiments of the invention utilize erase time stamps for erasable blocks as erase marks to reflect wear statuses for the data blocks and utilize a wear leveling seed to restrict wear leveling.

Concepts of the invention for time stamp and wear leveling seed are first illustrated. The time stamp represents a recorded system time in each erasable block in the EEPROM flash when an erase operation is executed, and the time stamp may be stored in different positions such as being stored within the erasable block, a fixed position in the EEPROM or an external space. The wear leveling seed is defined as a constant for restricting wear leveling time.

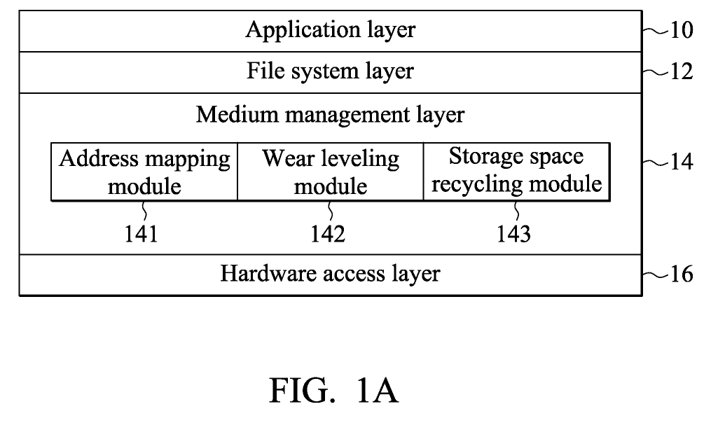

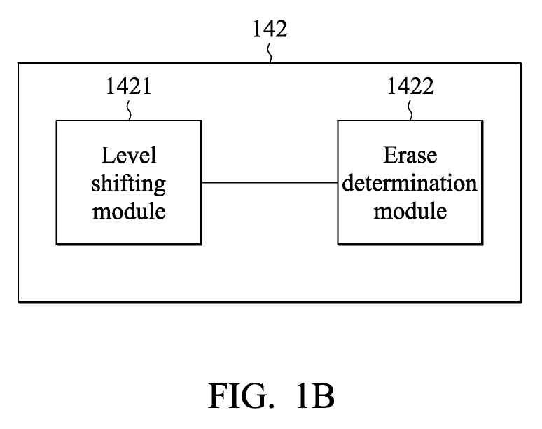

FIG. 1A shows a block diagram of an embodiment of an application system for a non volatile memory according to the invention, which is divided into four layers from top to bottom. The first layer represents an application layer 10, the second layer represents a file system layer 12, the third layer represents a medium management layer 14 and the fourth layer represents a hardware access layer 16. The medium management layer 14 at least comprises three parts, i.e. an address mapping module 141, a wear leveling module 142 and a storage space recycling module 143. The address mapping apparatus stores physical addresses of the data block and records a time value, i.e. the time stamp, corresponding to the data block after the data blocks have been erased. The wear leveling module 142 is connected to the address mapping module 141 for counting the erased time according to a random number and a wear leveling seed for leveling the erase time being performed for each data block in the multiple data blocks. The random number and the wear leveling seed are detailed in below. The storage space recycling module 143 manages the erased data blocks for data rewriting or reading. In another embodiment, the fourth layer is the NOR flash, i.e. a NOR-type flash memory. Although the medium management layer 14 may also comprise functions for managing bad blocks, bad block management is not an objective for the invention and thus detailed description is omitted.

The non volatile memory may comprise multiple data blocks and a key table which is formed according to the data blocks. Note that the invention is mainly applied in the wear leveling module 142 of the medium management layer software 14.

FIG. 1B shows a detailed structural diagram of an embodiment of a wear leveling module 142 according to the invention. The wear leveling module 142 comprises a level shifting module 1421 and an erase determination module 1422. The level shifting module 1421 may perform a bit shifting operation step to form the data blocks to a key table according to a sequence of time values of the time stamps corresponding to the data blocks. That is, the data block in the table header has the earliest erase time while data block in the table tail has the latest erase time. The erase determination module 1422 is coupled to the level shifting module 1421 and is capable of performing an erase determination step for determining whether to execute an erase operation for the data blocks in the key table, and selects the corresponding blocks to execute the erase operation according to a sequence of the time values of the data blocks.

The wear leveling module may also comprise a recording module for updating the time values of the data blocks (not shown in the figures). The recording module may be connected to the erase determination module 1422. When the erase operating is determined to be executed by the erase determination module 1422, the recording module obtains a current system time value and compares the current system time value with the latest time value that is stored within the plurality of data blocks when the current system time value is later than the latest time value, the recording module records the current system time value, and when the current system time value is earlier than the latest time value, the level shifting module 1421 adds a predetermined increment to the latest time value and configures the added time value to be the current system time value. Of course, the updating of the system time could be performed by the level shifting module 1421 or the erase determination module 1422 without an additional module. The combination or alternation of the idea in the invention may be understood by the skilled person in the art.

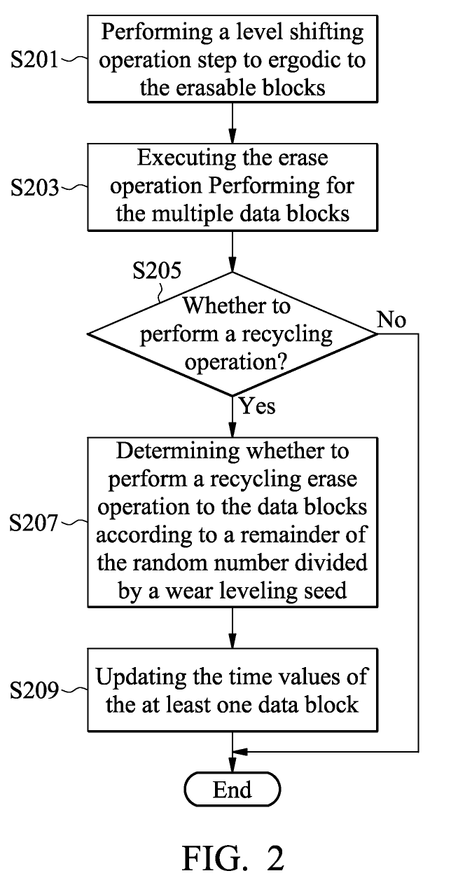

FIG. 2 is a flowchart showing an embodiment of a wear leveling erasing method according to the invention in which step S201 is a level shifting operation step for arranging a key table and the erasable blocks according to a sequence of the time value corresponding to the multiple data blocks. In one embodiment, the time value may be a recorded system time that represents the time in which the data block was last accessed. Step S203 selects the corresponding blocks to execute the erase operation according to a sequence of the time values of the data blocks in the key table formed by step S201. In step S205, it is determined whether to perform a recycling operation, wherein the determination condition may be that free spaces within the system are less than external request spaces or may be a disk arrangement operation or the like. In step S207, it is determined whether to perform a recycling erase operation to the data blocks via a wear leveling seed so as to control probability of the wear leveling occurrence. In step S209, the time values of the at least one data block is updated in response to the erase operation. The step S209 may be performed in combination with the step S207 in one embodiment of the invention. Further descriptions for the aforementioned steps are detailed below with references to the accompanying drawings.

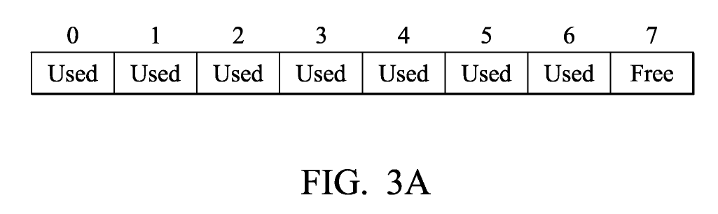

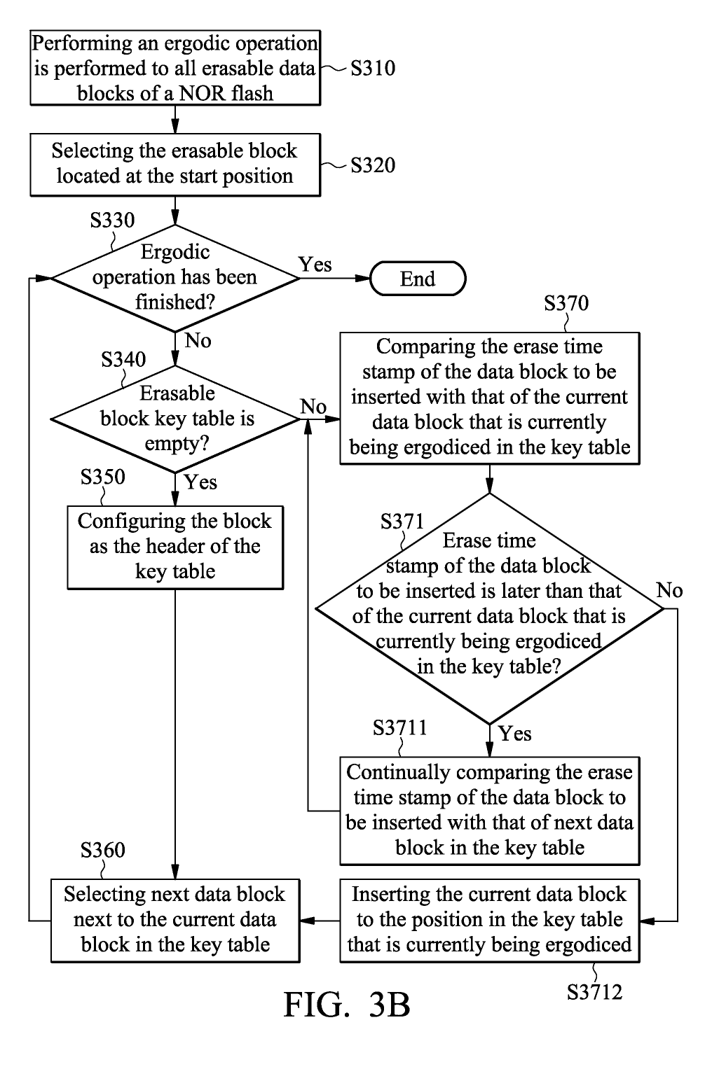

FIG. 3A shows a schematic diagram of an embodiment of a key table arranged according to a sequence of the time values according to the invention, wherein blocks 0-6 represent used erasable blocks and block 7 represents a free erasable block that is not being used. Data block 0 in the table header has the earliest erase time while data block 7 in the table tail has the latest erase time.

FIG. 3B is a flowchart showing an embodiment of establishing an erasable blocks key table according to a sequence of the erase time stamps according to the invention, i.e. step S201 in FIG. 2. Generally, the steps will be performed and completed in the initial stage. As an example, for a NOR flash, in step S310, an ergodic operation is performed to all erasable data blocks according to the physical sequence of the data blocks. Thereafter, in step S320, the erasable block located at the start position, i.e. the 0th erasable block, is selected. Then, in step S330, it is determined whether the ergodic operation has been finished. If so, the flow ends; otherwise, i.e. the ergodic operation is not finished, step S340 is further performed to determine whether the erasable block key table is empty. If the erasable block key table is empty, step S350 is performed such that the block is configured as the header of the key table. If the erasable block key table is not empty, step S370 is performed, starting from the table header of the key table, wherein the erase time stamp of the data block to be inserted is compared with that of the current data block that is currently being ergodiced in the key table. Next, in step S371, if the erase time stamp of the data block to be inserted is later than that of the current data block that is currently being ergodiced in the key table, step S3711 is further performed to continually compare the erase time stamp of the data block to be inserted with that of next data block in the key table and then determination in step S370 is again performed. If, in step S371, the erase time stamp to be inserted is earlier than that of the current data block that is currently being ergodiced in the key table, step S3712 is further performed to insert the current data block to the position in the key table that is currently being ergodiced and then step S360 is further performed. In step 360, next data block which is a data block next to the current one according to the physical sequence of the data blocks in the key table is selected and then determination in step S330 is again performed. It is to be noted that if the erase time stamp of the data block to be inserted is equal to that of the current data block that is currently being ergodiced in the key table, either step S3711 or S3712 may be performed depending on design requirements.

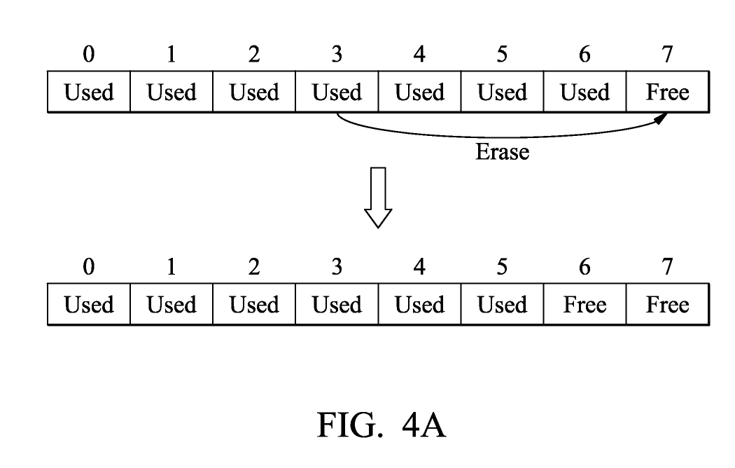

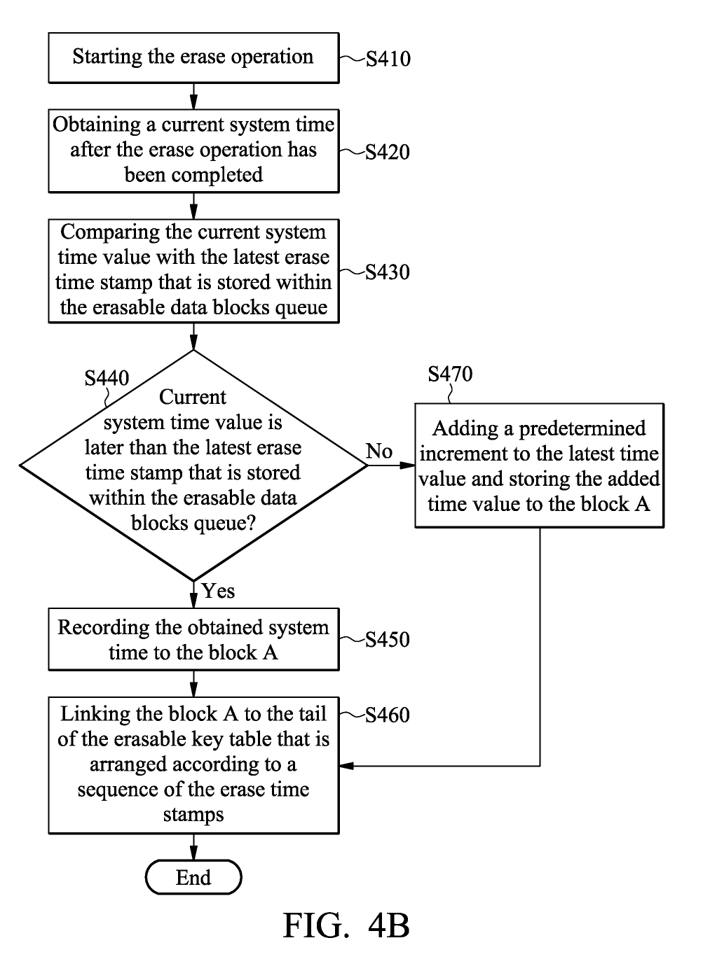

When the erase operation has been performed, a current system time value for when the erasable block was erased, i.e. a time stamp after the erase operation was performed, is needed to be recorded into the erasable block and then the block is linked to the tail of the key table. Referring to FIG. 4A, which shows a schematic diagram of an embodiment of an erase operation for erasing a time stamp key table according to the invention, as shown in FIG. 4A, the block 3 has been erased and the block 3 is linked to a location that is behind the erasable queue, i.e. behind the block 7, according to the erase time stamp recorded in the block 7. Thus, blocks 3-6 within the current key table are blocks 4-7 in the original key table and the block 7 is block 3 in the original key table.

FIG. 4B is a flowchart showing an embodiment of recording the erased time stamp to the erasable block according to the invention. In step S410, block A is confirmed to be erased and thus the erase operation is started. After the erase operation has been completed, in step S420, a current system time is obtained. Then, step S430 is performed to compare the current system time value with the latest erase time stamp that is stored within the erasable data blocks queue. In step S440, it is determined whether the current system time value is later than the latest erase time stamp that is stored within the erasable data blocks queue, when the current system time value is later than the latest time value, when recording the current system time value. If so, step S450 is performed to record the obtained system time to the block A. If the current system time value is earlier than the latest time value, when recording the current system time value, step S470 is performed to add a predetermined increment to the latest time value and then the added time value is stored to the block A. It is understood, that although the predetermined increment is typically 1, persons skilled in the art will appreciate that different increments may be selected according to user requirements.

After step 450 or step S470 has been successfully performed, step S460 is further performed such that the block A is linked to the tail of the erasable key table that is arranged according to a sequence of the erase time stamps. Thereafter, the step ends.

When free spaces within the system are less than external request spaces or the background operation of the system needs operations, such as a disk arrangement operation or the like, to be performed, a recycling process will be performed. When the recycling process is required to be performed for the system, a wear leveling seed may further be utilized to efficiently manage both the system performance and wear leveling seed.

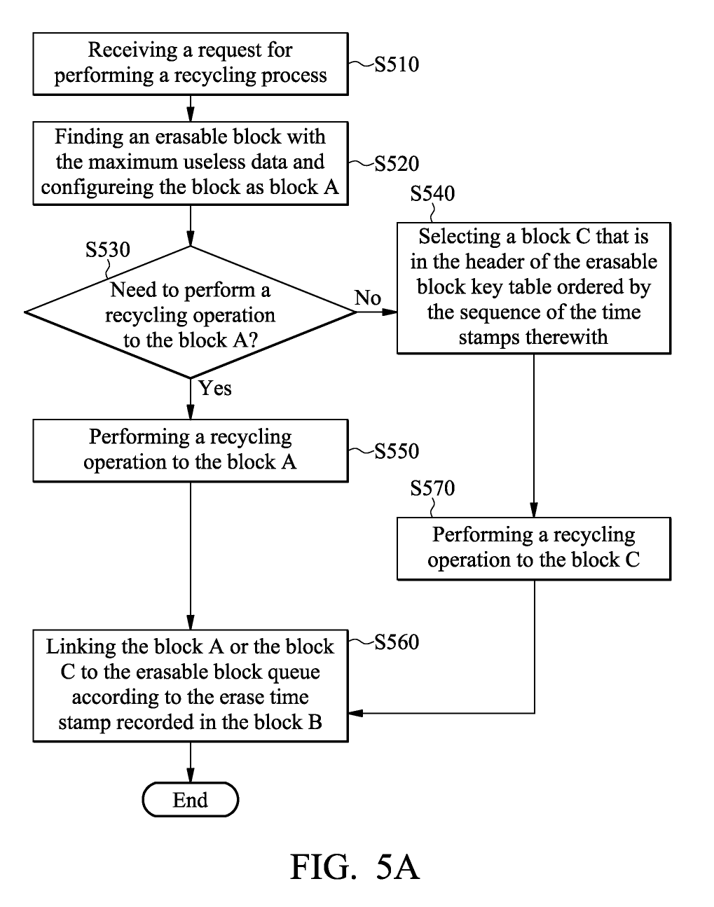

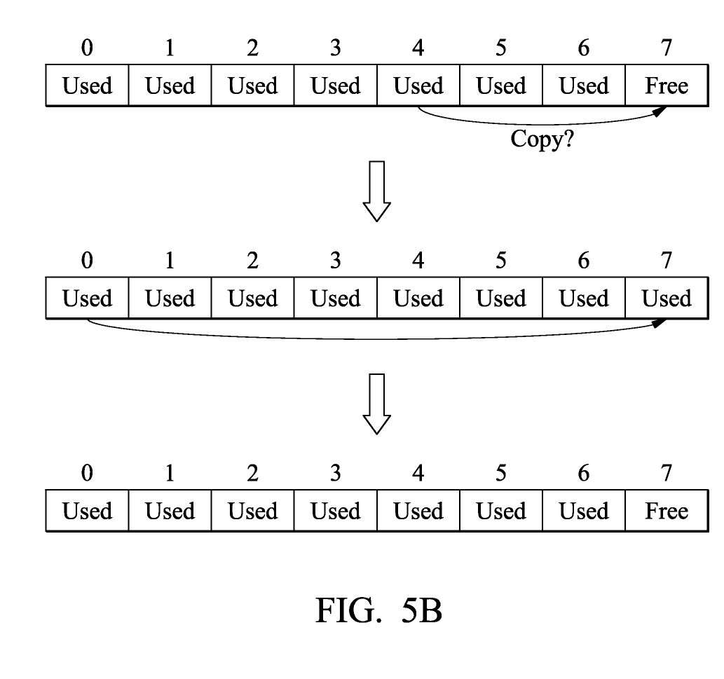

FIG. 5A is a flowchart showing an embodiment of a recycling process for the erasable blocks according to the invention, i.e. step S207 in FIG. 2. In step S510, a request for performing a recycling process to the storage space of the erasable blocks within the system is received. Thereafter, in step S520, the system finds an erasable block with the maximum useless data, i.e. the dirtiest block, according to the highest efficiency rule and configures the block as block A.

The dirtiest block mentioned in step S520 is detailed in the following. As an example, in a NOR flash, it is assumed that size of each erasable block is 64K and storage space of each erasable block can be arranged based on a sector size thereof. It is assumed that, in this embodiment, sector size of each erasable block is 128 bytes and thus one erasable block may comprise 512 sectors, wherein each sector has 128 bytes. When the file system writes data in an erasable block of the NOR flash, programming operations are performed thereto in which a sector is as a minimum written unit. In other words, at least 128 bytes will be written for each write operation.

Due to the characteristics of the NOR flash, data physically stored within the NOR flash can only vary from 1 to 0 rather than from 0 to 1 by the program operation. If the data must be varied from 0 to 1, the entire block must be erased and changed back to 1. In this case, when modification of data in a specific sector within the erasable block is required, the available data to be written can not be directly overlapped to the specific sector and instead, must be written into a free sector that is a sector without data from current blocks or other blocks and the sector that originally maps to the same logical address will be marked as a useless data sector.

To determine the dirtiest block, typically, all erasable blocks will be ergodiced when the system is initializing and a number of available data sectors, a number of useless data sectors and a number of free data sectors within the data blocks are calculated and stored into corresponding data structures in the system memory. During operation, the data structures are simultaneous updated. When attempting to determine the dirtiest block, only statistical information stored within the memory need to be accessed to determine a block that comprises maximum number of useless data sectors as the dirtiest block. In other words, an erasable block is referred to as the dirtiest block when the erasable block comprises the maximum number of useless data sectors, such as the block A in step S520. Techniques regarding determination of the dirtiest block are well-known, and thus detailed descriptions are omitted.

Referring again to FIG. 5A, step S530 is further performed to determine whether a recycling operation to the block A need to be performed according to the value of the configured wear leveling seed. The determination can be explained by following equation:

random % (wear-leveling seed)==1 (1),

wherein random represents a random number, which is a pseudo-random number (approximate to an ideal random number) in practice, obtained by standard functions random( ) or others. The wear-leveling seed represents a wear leveling seed which is typically a constant value obtained by experimentation. For example, if the wear leveling seed is set to be 50 and the random is an ideal random number, the probability of wear leveling occurrence is set to be 1/50 with a calculation by the Formula (1), i.e. the probability of wear leveling occurrence is restricted to 1/50. It is to be noted that a remainder of the random number divided by a wear leveling seed may be other values, such as 2, 3, and so on. As one skilled in the art will appreciate, the remainder may be configured to any value dependant upon design requirements.

The value of the wear leveling seed can be flexibly selected based on the capacity of the storage medium, by mainly selecting the experience value. However, as capacity of the storage medium increases, the blocks will grow in number and requirement for the wear leveling process will be reduced due to randomness existing, when the storage medium is used by the user. Thus, a large value can be selected as the value of the wear leveling seed.

Referring again to FIG. 5A, if the calculation result of random % (wear-leveling seed) in Formula (1) is not equal to 1, step S550 is performed to perform a recycling operation to the block A so that the available data within the block A will be copied to a free block B that is preserved by the system and the block A will be erased. If the calculation result of random % (wear-leveling seed) in Formula (1) is equal to 1, the recycling operation to the block A is not required and thus step S540 is performed to select a block C that is in the header of the erasable block key table ordered by the sequence of the time stamps therewith. The block C is the block with an earliest erase time stamp in the system. After, step S570 is performed to perform a recycling operation to the block C so that the available data within the block C will be copied to a free block B that is preserved by the system and the block C will be erased. After completion of step S550 or step S570, step S560 is further performed such that the block A or the block C is linked to the erasable block queue according to the erase time stamp recorded in the block B which is the block with the latest erase time stamp in the system and the steps end.

Regarding steps S530, S540, S570 to S560, please refer to FIG. 5B, which determines whether to perform a recycling operation 0 to the block 4 and copying the available data within the block 4 to the free block, preserved by the system, 7. Referring to Formula (1), a wear leveling process is required to be performed and thus a recycling operation is performed to the block 0 with the earliest erase time stamp in the table header of the erasable block table such that the available data within the block 0 will be copied to the free block 7 that is preserved by the system and the block 0 will be erased. Thereafter, the block 0 is linked to the erasable block queue according to the erase time stamp recorded in the block 7. After the block 7 has been linked to the erasable block queue, the recycling operation is completed. Note that blocks 0-6 in the current key table after the recycling operation has been performed are blocks 1-7 in the original key table and current block 7 is the original block 0. For detailed description regarding steps S530, S550 to S560, please refer to FIG. 4A.

Embodiments of the invention utilize erase time stamps for erasable blocks as erase marks to reflect wear statuses for the data blocks and utilize a wear leveling seed to restrict wear leveling. Thus, deviation in subsequent block wear leveling processes, wherein the erase count record of blocks do not match the actual useable lifespan of the blocks are prevented.

Wear leveling apparatuses and control methods thereof, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

Certain terms are used throughout the description and claims to refer to particular system components. As one skilled in the art will appreciate, consumer electronic equipment manufacturers may refer to a component by different names. This document does not intend to distinguish between components that differ in name but not function.

While the invention has been described by way of example and in terms of preferred embodiment, it is to be understood that the invention is not limited thereto. To the contrary, it is intended to cover various modifications and similar arrangements (as would be apparent to the skilled in the art). Therefore, the scope of the appended claims should be accorded to the broadest interpretation so as to encompass all such modifications and similar arrangements.

What is claimed is:

1. A wear leveling method for a non-volatile memory, wherein the non-volatile memory includes a plurality of data blocks and a key table corresponding to the plurality of data blocks, the method comprising:
arranging the key table according to a sequence of time values corresponding to the plurality of data blocks;
determining whether to execute an erase operation for at least one of the plurality of data blocks according to the arranged sequence of the plurality of data blocks indicated in the arranged key table; and
updating the time values of the at least one data block in response to the erase operation of the at least one data block is determined to be executed,

2. The wear leveling method as claimed in claim 1, said arranging the key table further comprising executing an ergodic operation according to the physical sequence of the plurality of data blocks.

3. The wear leveling method as claimed in claim 2, wherein when the key table is not empty, said executing the ergodic operation of the current data block in the key table, further comprising: comparing the time value of the data block to be inserted with that of the current data block starting from the table header, if the time value of the data block to be inserted is earlier than that of the current data block, inserting the current data block to the position in the key table that is currently being ergodiced.

4. The wear leveling method as claimed in claim 3, wherein if the time value of the data block to be inserted is later than that of the current data block, continually comparing the time value of the data block to be inserted with that of a next data block in the key table.

5. The wear leveling method as claimed in claim 1, wherein said determining whether to execute the erase operation further comprising:
when a remainder of a random number divided by a wear leveling seed is a specific value, selecting the data block with the earliest time value within the plurality of data blocks to execute a recycling erase operation, wherein the wear leveling seed corresponds to the erase time of the plurality of data blocks, the recycling erase operation is executed to erase the data block for reusing; and
when the remainder of the random number divided by a wear leveling seed is not the specific value, executing the recycling erase operation to a data block that has maximum useless data.

6. The wear leveling method as claimed in claim 5, wherein said recycling erase operation further comprising:
rewriting and marking at least one of the plurality of data blocks to be erased with a certain value.

7. The wear leveling method as claimed in claim 1, wherein said updating the time values of at least one of the plurality of data blocks when the erase operation is executed, the method further comprises:
obtaining a current system time value and comparing the current system time value with the latest time value that is stored within the plurality of data blocks;
when the current system time value is later than the latest time value, recording the current system time value; and
when the current system time value is earlier than the latest time value, adding a predetermined increment to the latest time value and configuring the added time value to be the current system time value.

8. The wear leveling method as claimed in claim 1, further comprising:
recording the current system time value for the data block that is currently executing the erase operation, and linking the data block corresponding to the recorded current system time to a location next to the data block with the latest time value.

9. A wear leveling apparatus for a non-volatile memory, wherein the non-volatile memory includes a plurality of data blocks and a key table corresponding to the plurality of data blocks, the apparatus comprising:
a level shifting module, arranging the key table according to a sequence of time values corresponding to the plurality of data blocks;
an erase determination module coupled to the level shifting module, determining whether to execute an erase operation for at least one of the plurality of data blocks according to the arranged sequence of the plurality of data blocks indicated in the arranged key table; and
a recording module, couple to the erase determination module, updating the time values of the at least one data block in response to the erase operation of the at least one data block is determined to be executed.

10. The wear leveling apparatus as claimed in claim 9, wherein said level shifting module further comprising executing an ergodic operation according to the physical sequence of the plurality of data blocks.

11. The wear leveling apparatus as claimed in claim 10, wherein when the key table is not empty, the level shifting module executes the ergodic operation of the current data block in the key table, and compares the time value of the data block to be inserted with that of the current data block, starting from the table header, if the time value of the data block to be inserted is earlier than that of the current data block, the current data block is inserted to the position in the key table that is currently being ergodiced.

12. The wear leveling apparatus as claimed in claim 11, wherein if the time value of the data block to be inserted is later than that of the current data block, the level shifting module continually compares the time value of the data block to be inserted with that of a next data block in the key table.

13. The wear leveling apparatus as claimed in claim 9, wherein said erase determining module further comprising:
when a remainder of a random number divided by a wear leveling seed is a specific value, the erase determination module selects a data block with the earliest time value within the plurality of data blocks to execute a recycling erase operation, wherein the wear leveling seed corresponds to the erase time of the plurality of data blocks, the recycling erase operation is executed to erase the data block for reusing, and
when the remainder of the random number divided by a wear leveling seed is not the specific value, the erase determination module executes the recycling erase operation to a data block that has maximum useless data.

14. The wear leveling apparatus as claimed in claim 13, wherein said recycling erase operation further comprising:
rewriting and marking at least one of the plurality of data block to be erased with a certain value.

15. The wear leveling apparatus as claimed in claim 9, wherein when the erase operation is executed, the apparatus further comprising:
the recording module obtains a current system time value and compares the current system time value with the latest time value that is stored within the plurality of data blocks;
when the current system time value is later than the latest time value, the recording module records the current system time value; and
when the current system time value is earlier than the latest time value, the recording module adds a predetermined increment to the latest time value and configures the added time value to be the current system time value.

16. The wear leveling apparatus as claimed in claim 10, further comprising:
the recording module records the current system time value for the data block that is currently executing the erase operation and links the data block corresponding to the recorded current system time to a location next to the data block with the latest time value.

17. A memory system, comprising:
a plurality of data blocks and a key table corresponding to the plurality of data blocks, wherein the data blocks are erasable;
an address mapping apparatus, storing physical addresses of the plurality of data blocks and recording a time value corresponding to the plurality of data blocks after at least one of the plurality of data blocks have been erased;
a wear leveling apparatus connected to the address mapping apparatus, determining whether to execute a recycling erase operation for the plurality of data blocks according to a random number and a wear leveling seed; and
a storage space recycling apparatus, managing the erased at least one of the plurality of data blocks for data rewriting or reading.
